(19) United States
(12) Patent Application Publication
(10) Pub. No.: US 2006/0130397 A1
(43) Pub. Date: Jun. 22, 2006

(54) Soil additive

(76) Inventors: Treers Huw, Stotts Island, New South Wales (AU); Donna Sheehy, Stotts Island, New South Wales (AU)

Correspondence Address: Smith Gambrell & Russell, 1850 M Street N W, Suite 800, Washington, DC, 20036, US

(21) Appl. No.: 10/519,366

(22) PCT Filed: May 26, 2003
(86) PCT No.: PCT/AU03/00642

§ 371 Date: Oct. 13, 2005

(30) Foreign Application Priority Data
Jul. 11, 2002 (AU) 2002950123

(51) Int. Cl. C09K 17/14

(52) U.S. Cl. 47/58.1 SC

(57) ABSTRACT

A soil additive produced from crushing, grinding and blending specified source rocks wherein a final product contains at least three of andesite, basalt, limestone, dolomite and claystone.

### FIELD OF THE INVENTION

The present invention relates to a soil treatment and in particular to a soil additive to assist in ecologically sustainable development.

### BACKGROUND ART

The anthropogenic improvement of current agricultural lands, and expansion of agriculture into more marginal lands can be attributed to the development of improved and more efficient tillage, drainage, irrigation and especially synthetic fertilisers and soil conditioners. Greatly improved yields and intensive cropping have been the result of improved agricultural practices, but with each harvest, a good deal of basic macro- and micronutrients are removed from the soil in the form of plant tissues.

Replenishment of these macro- and micronutrients is usually undertaken by natural sedimentation processes such as floods, which take rich igneous, volcanic, biogenic and re-worked sedimentary rocks from eroding valley walls and deposit them onto the floodplains. Rich flood sediments re-mineralise soil systems such that they support large colonies of Nitrogen cycling bacteria and become ‘fertile’ (that is, the soil is capable of providing balanced quantities of Nitrogen, Phosphorus, Potassium and other macro- and micronutrients).

Extensive drainage systems, intensive irrigation and the increased use of synthetic fertilisers can essentially replace the natural system, allowing for minimal sedimentary input. Long-term impacts of intensive cropping include imbalances in favourable nutrient supplies, increasing concentrations of toxic, acidifying, or plant growth restricting elements (e.g. Aluminium, Hydrogen, Manganese, Iron, etc.), and a physical reduction of soil depth and mass with each harvest that removes a certain proportion of processed elements and minerals. Irrigation and rainfall can leach nutrient elements from the soil, especially well in degraded soils, where efficient drainage systems transport them directly to natural watercourses causing eutrophication of intrinsically low-nutrient demand ecosystems.

Concurrently, the leaching of favourable nutrients and increasing concentration of unfavourable elements acidifies soil horizons, virtually locking land managers into an unsustainable cycle of excessive synthetic fertiliser applications on soils that are becoming less able to efficiently hold nutrients and effectively unable support economically viable crops.

As each harvest removes a proportion of converted soil material that is not replaced by natural sedimentation processes, the increased incidence of conditions such as land acidification and Acid Sulfate Soils (ASS) are become evident. Sub-soil layers previously concealed by viable topsoils have begun to emerge where, in the case of ASSs, oxidation reactions lead to widespread land acidification and complete soil degradation.

One common method adopted by agricultural operators and developers operating in or managing acidified, acid sulfate, overworked, low calcium alkaline, poor retention, sandy alluvial, and a range of starved soil conditions, is to apply processed carbonate based minerals derived from limestone or lime. The function of these additives is to improve or raise soil pH in order to allow the soil to retain and supply more of the essential plant growth elements (e.g. Calcium, Sulphur, Magnesium, Nitrogen, Phosphorus, Potassium, etc.); and to improve conditions for important Nitrogen cycling soil microbes.

Sources of lime materials may include limestone, dolomite, mixed lime, burnt lime (quicklime) and hydrated lime (slaked lime). These additives are associated with greenhouse gas emissions.

Treatment methods currently being used for soils include soil washing, incineration, and biotreatment. Soil washing involves removal of hazardous chemicals from soils using solvents, but the solvent stream must still be treated for destruction of contaminants. Incineration is an effective tool for destruction of contaminants but is costly and lacks public acceptance.

Bioremediation has been considered and used for treatment of soils contaminated with wood-treatment chemicals, but bioremediation leaves the most toxic, carcinogenic, and regulated chemicals in the soil. Slurry-phase biotreatment of contaminated soils and sediments is an innovative treatment technology. Its advantages include easy manipulation of physio-chemical variables and operating conditions to enhance rates of biodegradation and ease of containment of exhaust gases and effluent. Bio-slurry technology is currently hampered by some bottlenecks that need to be relieved.

Foam remediation technologies have the potential to increase the applicability of in-situ bioremediation. Unlike other approaches, foams can be designed to remove pollutants and enhance bioremediation simultaneously. Although foams have been applied successfully underground for enhanced oil recovery, they have not yet been systematically applied to environmental remediation problems closer to the surface. Developers are exploring the opportunity to adapt and mature this existing technology for environmental remediation purposes, such as for the cleanup of hazardous waste.

It is anticipated that foam remediation technology can be applied to both the saturated and vadose zones for remediation of soils contaminated with either chlorinated organics, such as trichloroethylene and carbon tetrachloride, or polyaromatic hydrocarbons, such as chrysene, benz(a)anthracene, anthracene, fluoranthene, or phenanthrene.

Current technologies for the in-situ remediation of soils contaminated with metals also require invasive reagent delivery systems. Typical volume increases on the order of 20 to 30 percent are encountered and cost escalations are witnessed due to the mixing process. In order to eliminate the problems associated with mixing of the reagents and the contaminated soils, projects have explored the use of liquid stabilisation reagents for the in-situ remediation of soils contaminated with metals.

Field tests consist of applying two percent by weight of the geochemical fixation reagent to the top six inches of soil. The reagent is expected to be a form of fertiliser.

The above methods of remediation are cutting edge and are therefore often expensive or complex. Also the traditional method of treatment for remediation of acidic and acid sulfate soils (ASS) is to use a soil additive which is basic as opposed to acidic. The soil additive most generally used is a traditional carbonate derived from limestone or lime. These additives are associated with greenhouse gas emissions.

The inventors of the present invention found a surprising blend of volcanic, biogenic and sedimentary rocks, which accomplishes the pH rise well and in a balanced way. Biogenic sediments—including the carbonate, phosphatic and biosiliceous sediments, as well as sedimentary organic carbon—record the spatial and temporal heterogeneity of biologically mediated sedimentary processes. In turn, biogenic sedimentation influences local, regional, and global atmospheric and oceanic environments, by acting as sinks for the nutrient elements that drive bio-geochemical cycles. The inventors also found that their invention can be used in the following applications:
For the development, management and remediation of acidic and Acid Sulfate Soils (ASS);
For the development, management and remediation of acidic materials and leachate;
For the development, management and remediation of alkaline soils;
For use in agricultural operations located on saline soils to enhance plant tolerance to saline conditions;
For use in agricultural practices located on ASS and acidic soils to enhance plant tolerance to saline conditions where tidal flushing practices are used to buffer drain acidity;
For use in agricultural practices, operation, remediation works and development;
For use in sandy materials to enhance treatment retention characteristics to reduce the effects of product leaching;
For the management and remediation of earth materials and leachate involved with development, mining and construction industries;
For the management and remediation of industrial waste; and

For general use as a partial or full replacement of traditional carbonate derived limestone and liming products to reduce greenhouse gas emissions.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a soil additive and methods for producing same, which may at least partially overcome the abovementioned disadvantages or provide the consumer with a useful commercial choice.

In one form, the invention resides in a soil additive produced from crushing, grinding and blending specified source rocks wherein the final product contains at least three of andesite, basalt, limestone, dolomite and claystone.

This invention may provide an anthropogenic input to soil or materials, using substances, which natural processes may provide under theoretical-optimum environmental conditions to address the problems of acidity, acidic conditions and many other environmental conditions.

Each source rock may preferably be crushed separately from the other types of source rock. The rock may also be ground to specific grain sizes to exploit each source rock's target attributes. It may also allow for a degree of sustained breakdown or temporal management of the final product to facilitate dosage rate calculations.

The grinding and/or blending of the dusts may preferably be designed to exploit the crystalline structure of the target mineralogy of each component in the source rock. The blending stage may be used to encourage grain impregnation of the temporal and chemical target attribute requirement of the final product.

When crushing operations are carried out using wet methods, all the crushing waters are preferably retained for blending with other crushing products, grinding products and any evaporates.

In a first preferred form, the invention resides in a soil additive produced from crushing, grinding and blending specified source rocks wherein the final product has a modal abundance of basalt in the range of 11% to 91%, limestone in the range of 1% to 59%, dolomite in the range of 0.025% to 30% and claystone in the range of 0% to 17.5%.

In a second preferred form, the invention resides in a soil additive produced from crushing, grinding and blending specified source rocks wherein the final product has a modal abundance of basalt in the range of 50% to 90.5%, limestone in the range of 1% to 22.5%, dolomite in the range of 0.25% to 12.5% and claystone in the range of 0% to 17.5%.

In this form, the product or final blend may preferably be used as a planning grade, long-term product. The product may possess a long life span allowing for use during the planning stage of development and agricultural activity. It may offer pH buffering abilities and material pH self-regulation enhancement. Another feature may preferably be an insitu retention ability suited to sandy materials and heavy leaching conditions. The product may also possess indirect environmental benefits.

The product may be used for pre-development conditioning of substrate soils, an alternative to agricultural liming practices to lower CO₂ emissions and fertilizer requirements, broadscale treatment practices of large volumes of soil and material and associated operations. In this form, the final product may preferably be crushed or ground to coarser grain sizes, which may suitably range from approximately 0.04 millimeters to 1.5 millimetres.

In a third preferred form, the invention resides in a soil additive produced from crushing, grinding and blending source rocks wherein the final product has a modal abundance of basalt in the range of 50% to 81.5%, limestone in the range of 3% to 28.5%, dolomite in the range of 0.5% to 18.5% and claystone in the range of 0% to 12%.

In this form, the product or final blend may preferably be used as a management grade, short-term product. The product may possess a medium life span with high product retention ability.

The product may preferably be used for open-air operations involving acid sulfate soil (ASS) horizons, infrastructure bunding/protection in acidic soils/substrates, ongoing mine tailings treatment, and an alternative for agricultural liming practices to lower CO₂ emissions and fertilizer requirements. In this form, the final product may preferably be crushed or ground to finer grain sizes which may suitably range from approximately 0.040 millimetres to 1.5 millimetres.

In a fourth preferred form, the invention resides in a soil additive produced from blending source rocks wherein the final product has a modal abundance of basalt in the range of 11% to 79.5%, limestone in the range of 10% to 59%, dolomite in the range of 1% to 30% and claystone in the range of 0% to 8%.

In this form, the final product or final blend may preferably be used as a shock grade, immediate product. The product may possess a moderate life span with immediate active results in raising the pH of soils, material and associated leachate.

The product may preferably be used for acidic leachate-generating event management, urgent soil, water and material pH buffering, treatment of ASS and acidic materials and agricultural liming practices to lower CO₂ emissions and fertilizer requirements. In this form, the final product may preferably be crushed or ground to finer grainsizes which may suitably range from 0.30 millimetres to 1.5 millimetres.

In a fifth preferred form, the invention resides in a soil additive produced from blending source rocks wherein the final product has a modal abundance of andesite in the range of 0-20%, limestone in the range of 0-45%, dolomite in the range of 0-20%, and basalt in the range of 50-85%.

In a sixth preferred form, the invention resides in a soil additive produced from blending source rocks wherein the final product has a modal abundance of andesite in the range of 0-20%, limestone in the range of 0-30%, dolomite in the range of 0-10%, and basalt in the range of 60-85%.

In this form, the product or final blend may preferably be used as a planning grade, long-term product. The product may possess a long life span allowing for use during the planning stage of development and agricultural activity. It may offer pH buffering abilities and material pH self-regulation enhancement. Another feature may preferably be an insitu retention ability suited to sandy materials and heavy leaching. The product may also possess indirect environmental benefits.

The product may be used for pre-development conditioning of substrate soils, agricultural liming practices to lower CO₂ emissions and fertilizer requirements, broad scale treatment practices of large volumes of soil and material and associated operations. In this form, the final product may preferably be crushed or ground to coarser grain sizes which may suitably range from approximately 60 microns to 2 mm.

In a seventh preferred form, the invention resides in a soil additive produced from blending source rocks wherein the final product has a modal abundance of andesite in the range of 0-15%, limestone in the range of 0-45%, dolomite in the range of 0-15%, and basalt in the range of 55-80%.

In this form, the product or final blend may preferably be used as a management grade, short-term product. The product may possess a medium life span with high product retention ability.

The product may preferably be used for open-air operations involving acid sulfate soil (ASS) horizons, infrastructure bunding/protection in acidic soils/substrates, ongoing mine tailings treatment, and agricultural liming practices to lower CO₂ emissions and fertilizer requirements. In this form, the final product may preferably be crushed or ground to finer grain sizes which may suitably range from approximately 40 microns to 2 mm.

In an eigth preferred form, the invention resides in a soil additive produced from blending source rocks wherein the final product has a modal abundance of andesite in the range of 0-15%, limestone in the range of 0-45%, dolomite in the range of 0-20%, and basalt in the range of 50-75%.

In this form, the product or final blend may preferably be used as a shock grade, immediate product. The product may possess a moderate life span with immediate active results in raising the pH of soils, material and associated leachate.

The product may preferably be used for acidic leachate-generating event management, urgent soil, water and material pH buffering, treatment of ASS and acidic materials and agricultural liming practices to lower CO₂ emissions and fertilizer requirements. In this form, the final product may preferably be crushed or ground to finer grain sizes which may suitably range from approximately 20 microns to 2 mm.

In a ninth preferred form, the invention resides in a soil additive produced from blending the crushing waters from crushing a first source rock containing at least one of andesite, limestone, dolomite, basalt and claystone with the crushing waters from crushing at least one second source rock containing at least three of andesite, limestone, dolomite, basalt and claystone.

In this form, the product or final blend may preferably be used as an all-purpose grade, pH raising liquid concentrate. The product may be used as a liquid shock treatment, dilutable to dosage and risk requirements/grade strength. It may be suitable for an extensive range of operations and applications.

The product may preferably be used for acidic leachate-generating event management, urgent soil, water and material pH buffering, treatment of ASS and acidic materials and agricultural liming practices to lower CO₂ emissions and fertilizer requirements. In this form, the final product may preferably be concentrated to achieve a dilutable liquid pH buffering solution and treatment spray.

In a tenth preferred form, the invention may reside in a method for producing a soil additive comprising the steps of
a. conducting analysis of mineralogy and/or crystalline structure of bulk rocks to determine the applicability of the bulk rocks to be used as a limestone source rock, a basalt source rock, a dolomite source rock or a claystone source rock, each source rock
b. crushing each of the source rocks identified in the analysis,
c. size analysis of each of the source rocks to determine whether each source rock is of a predetermined size,
d. grinding of each of the source rocks, and
e. blending of the source rocks to give a final blend.

According to this form of the invention, once identified, each of the source rocks undergo a series of processes. The differing soil additive compositions described herein are formed by the application of combinations of processes on each source rock. Preferably the processes and particularly the blending stage allow the invention to form different products with the desired minerals or rocks in required modal abundance at optimum particle sizes for the product.

Preferably the source rocks are each processed in a separate processing stream. The products from each separate processing stream are ultimately combined to form the final blend.

The source rocks undergo analysis to determine the mineralogical, physical and textural suitability for use in the invention. This analysis suitably involves identifying a series of mineralogical and textural characteristics highly desired in source rocks to be used in the invention. The preferred individual source rocks and their desired attributes on which the analysis may be conducted are individually defined immediately below:

BASALT: Basalt, in this instance, refers to aphanitic, basic, mafic, igneous rock. Basalts are low Si rocks, with SiO₂ generally below 53%, with a range of compositional variations particularly in relation to Mg and Fe ratios and alkali contents. The primary method for determination of suitability of a particular basalt deposit for use in the invention may be by microscopic petrographic analyses to determine an approximate composition of the rock, expressed in volume percent (referred to as ‘modal abundance’ in this instance) and based on a brief count of 100 widely spaced points in thin section.

Further recommendations for basalt selection may preferably include:
Where production and final product are primarily directed towards operations, remediation and development of iron rich materials and leachate (such as ASS) the basalt source rock may preferably contain less than 6% modal abundance of olivine where the olivine content of the proposed source rock basalt is at or near the fayalite end member of the olivine group of orthosilicates. Limitation on using basalt with the iron rich end member of the olivine group may reduce overall levels of iron content in the final product as a precautionary measure should concern arise.
Where the olivine content of the proposed source basalt is at or near the Magnesium enriched forsterite end member of this mineral group, the basalt is highly suitable for use on iron rich materials and leachate, with recommended limitations on final olivine modal abundance not applicable.
Where production and final product are primarily directed towards operations, remediation and development of iron rich materials and leachate the basalt source rock may preferably contain less than 8% magnetite where magnetite represents the primary opaque oxide. Limitation on using basalt with excessive magnetite may reduce overall levels of iron content in the final product as a precautionary measure should concern arise.
Where the opaque oxide content of the proposed source basalt contains more than 40% ilmenite, the basalt is highly suitable for use on iron rich materials and leachate, with recommended limitations on magnetite modal abundance not applicable.

CLAYSTONE: Claystone in this instance refers to the claystone members within the broad ‘mudstone rock’ group.

The suitable claystone for use in the invention may be identified in hand specimen by the soft powdery texture when dry and malleable nature of the rock when wet. Colour may vary greatly but may provide a useful primary tool in determining the suitability of a deposit for use in the invention. In the instance where compositional banding is present, providing a range of colours, the two dominant colours are preferably used in preliminary source rock evaluation. Where colour ranges from near colourless to yellow brown this indicates a strong illite content and this claystone may be highly suitable for use in the invention. Where colour ranges from colourless to pale yellow this indicates the kaolin group of minerals (dickite, halloysite, nacrite and kaolinite) these clays are also preferable for use in the invention.

Where colour ranges are deep red-brown to browns and have a greasy texture between the fingers this may indicate the clay to be of the smectite or montmorillonite group. These clays exhibit shrink/swell capabilities and may be less suitable for use in the invention where the final product is to be used in construction operations. Additions of smectite dominated claystone are preferably kept below 50% of the preferred claystone content of the final products of the invention. Further recommendations for Claystone selection may suitably include:
where concretions constitute more than 30% of the claystone and are greater than 0.05 millimetres in average size, the deposit is not recommended for use in the invention;,
where abundant iron concretions coalesce these clays are also not recommended for use in the invention;
where the source rock deposit has undergone regional, contact or localised metamorphism to no greater than the phyllite grade of alteration and mineralogical composition has not altered completely to or near pelitic composition the source rock remains suitable for use in the invention where the original sedimentary fabric remains visible to the naked eye in hand specimen.

LIMESTONE: In this instance ‘limestone’ refers to any rock where the proportion of carbonate material exceeds the remaining constituents with the exception of dolomite (90-100% dolomite), dolomitic limestone (10 to 50% dolomite) and calcareous dolomite (50-90% dolomite).

In hand specimen the preferred limestone should not display heavy iron oxide stains/staining along cleavage and grain boundaries, as this may be indicative of excessive siderite content. The primary determining factor for the selection of source rock limestone may be the determination of the optimum potential Effective Neutralising Value (ENV) a deposit may attain, that is 100% times the Neutralising Value (NV) of the limestone. Where the NV, determined by laboratory analysis, of the proposed limestone source rock is greater than 95%, the limestone may be highly suitable for use in the invention as the grinding stage ensures the optimum potential ENV is attained. Where the NV, determined by laboratory analysis, is below 95% but greater than 92%, the proposed limestone source rock may be suitable for use in the invention where the limestone component of the entire individual product blend, is added at high rates (“high rates” in this instance refer to the upper 50 percentile fraction of the total recommended range) with respect to ranges specified in each mode of the invention. Further recommendations for limestone source rock selection may include:
Limestone/s for use in the invention may preferably have siderite content below 10% of their modal abundance to assist in reducing overall final product iron content as a precautionary measure where iron levels are of concern.
Where a limestone has an average abundance, determined by laboratory analysis, equal to or greater than:
   1 mg per kilogram of cadmium, and/or;
   20 mg per kilogram of lead, and/or;
   0.2 mg per kilogram of mercury the limestone may be highly unsuitable for use in the invention. This restriction negates the risk of exceeding Maximum Permissible Concentration (MPC) levels of residues capable of accumulation in soil, plant and animal products.

DOLOMITE: In this instance dolomite refers to the digenetic carbonate mineral assemblage found in magnesium rich limestone and commonly known as dolomite, dolostone, calcic dolomite, dololithe and dolomitic limestone. Selection of optimum dolomite source rocks may be difficult as the dolomization process often destroys sedimentary fabric.

Determination of a potential source rock deposits suitability for use in the invention generally requires laboratory analyses to obtain calcium and magnesium as carbonate levels as a percentage of total rock modal abundance. Where a potential source rock deposit has below 15% magnesium as carbonate and at least 12% calcium content the deposit may be highly suitable for use in the invention.

The crushing step may mill the source rocks to a particular size fraction. The size fraction required at this stage may preferably be at or below 20 mm. The crushing step may preferably be performed under dry conditions but is suitable under wet conditions. This stage may require stock to feed and re-feed through a single crushing unit or may preferably feed through a larger stock feed crushing unit through into a small stock feed crushing unit to reduce energy required to complete stage.

After the crushing stage, all production lines may preferably be subjected to size determination to ensure the correct size fraction is obtained during the crushing stage. The basalt and dolomite lines may suitably also be subject to neutralising value and/or attribute analysis.

One or more stockpiling and/or drying steps may be used according to the method. This stage may removes some of the waters that may have been added in the crushing stage.

The next step may suitably be a grinding stage. Grinding is a process utilizing machinery different to that used in crushing stage. Crushing generally gives a courser product than grinding. All lines may be finely ground to give a grinding size fraction in the preferred size range of 0.030 millimetres up to 1.5 millimetres.

Where the basalt size fraction ranges from 0.030 millimetres to 0.080 millimetres optimum performance for this embodiment of the invention may preferably be realised. Basalt size fractions up to a maximum grainsize no greater than 1.2 millimetres may be suitable for use in the invention where no greater than 30% of the entire basalt component is above the upper optimum performance grainsize of 0.080 millimetres.

Where the limestone size fraction ranges from 0.030 millimetres to 0.090 millimetres, optimum performance of limestone for this embodiment of the invention may preferably be realised. Limestone size fractions up to a maximum grainsize no greater than 0.3 millimetres may be suitable for use in the invention where no greater than 50% of the entire limestone component is above the upper optimum performance grainsize of 0.090 millimetres.

Where the dolomite size fraction ranges from 0.030 millimetres to 0.5 millimetres optimum performance for dolomite in this embodiment of the invention may preferably be realised. Dolomite size fractions up to a maximum grainsize no greater than 1.5 millimetres may be suitable for use in the invention where no greater than 30% of the entire dolomite component is above the upper optimum performance grainsize of 0.5 millimetres.

Where the claystone size fraction ranges from 0.040 millimetres to 0.5 millimetres optimum performance for claystone in this embodiment of the invention may preferably be realised. Claystone size fractions up to a maximum grainsize no greater than 1.5 millimetres may be suitable for use in the invention where no greater than 30% of the entire claystone component is above the upper optimum performance grainsize of 0.080 millimetres.

After the grinding stage, the limestone production line may tested for neutralising value and/or attribute analysis to preferably ensure all grains are below 0.3 mm and preferably within the required size range of 0.030 millimetres to 0.090 millimetres, so that optimum neutralising value of the limestone line may be attained.

The basalt and dolomite lines may be stockpiled or refined to ensure the required quantity of each rock or mineral is present at the desired grainsize range after grinding, before they are blended with the limestone line which exits the neutralising value and/or attribute analysis.

The blend of the three minerals/rocks exiting the refining stage, may be stockpiled. The blend may then be further blended with the claystone exiting grinding stage to form the final product.

The final stage in this process may be a quality check of neutralising value and/or attribute analysis to ensure product quality and that the required rocks/minerals are present in the desired modal abundances. The product may then proceed to packing and distribution.

### BRIEF DESCRIPTION OF THE DRAWINGS

Various embodiments of the invention will be described with reference to the following drawings, in which:

FIG. 1 shows the process according to one preferred aspect of the invention.

FIG. 2 shows the process according to another preferred aspect of the invention.

FIG. 3 shows the process according to yet another preferred aspect of the invention.

### DETAILED DESCRIPTION OF THE INVENTION

According to a first aspect of the invention, a soil additive produced from crushing, grinding and blending source rock containing at least three of basalt, limestone, dolomite and claystone.

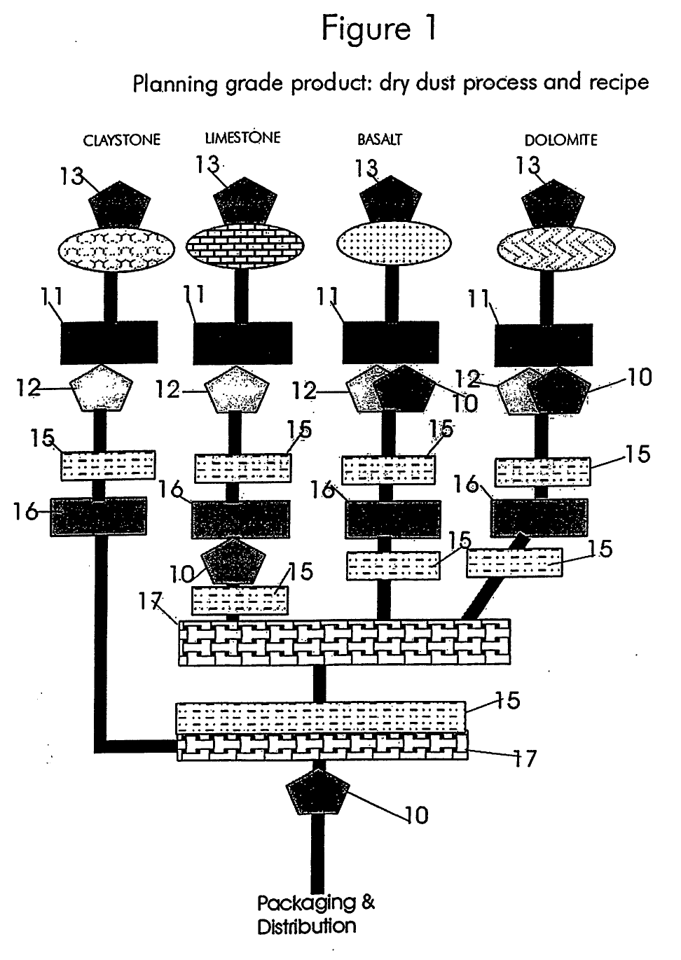

As can be seen from FIG. 1, the soil additive is a blend wherein the final product contains components in given modal abundance.

According to the invention, the products of each embodiment undergo a series of processes. The differing products are formed by the application of different combinations of processes on source rock containing similar components. The different processes and particularly the blending stage 17 allow the invention to form different products with the desired minerals or rocks in required modal abundance at optimum particle sizes for the product.

Unless otherwise stated in the following description, the lines of basalt, limestone, dolomite and claystone described below for stage 13, are all processed separately.

In a first embodiment, the final product is produced according to the production flowsheet given in FIG. 1 and is the planning grade product described above. The overall process may be explained by analysing the series of subsidiary processes involved.

The source rocks undergo analysis 13 to determine the mineralogical, physical and textural suitability for use in the invention. This analysis 13 involves, identifying a series of mineralogical and textural characteristics highly desired in source rocks to be used in the invention. The preferred individual source rocks and their desired attributes to complete analysis 13 are individually defined immediately below:

BASALT: Basalt, in this instance, refers to aphanitic, basic, mafic, igneous rock. Basalts are low Si rocks, with SiO₂ generally below 53%, with a range of compositional variations particularly in relation to Mg and Fe ratios and alkali contents. The primary method for determination of suitability of a particular basalt deposit for use in the invention is by microscopic petrographic analyses to determine an approximate composition of the rock, expressed in volume percent (referred to as ‘modal abundance’ in this instance) and based on a brief count of 100 widely spaced points in thin section.

Further recommendations for basalt selection include:
Where production and final product are primarily directed towards operations, remediation and development of iron rich materials and leachate (such as ASS) the basalt source rock may preferably contain less than 6% modal abundance of olivine where the olivine content of the proposed source rock basalt is at or near the fayalite end member of the olivine group of orthosilicates. Limitation on using basalt with the iron rich end member of the olivine group may reduce overall levels of iron content in the final product as a precautionary measure should concern arise.
Where the olivine content of the proposed source basalt is at or near the Magnesium enriched forsterite end member of this mineral group, the basalt is highly suitable for use on iron rich materials and leachate, with recommended limitations on final olivine modal abundance not applicable.
Where production and final product are primarily directed towards operations, remediation and development of iron rich materials and leachate the basalt source rock may preferably contain less than 8% magnetite where magnetite represents the primary opaque oxide. Limitation on using basalt with excessive magnetite may reduce overall levels of iron content in the final product as a precautionary measure should concern arise.
Where the opaque oxide content of the proposed source basalt contains more than 40% ilmenite, the basalt is highly suitable for use on iron rich materials and leachate, with recommended limitations on magnetite modal abundance not applicable.

CLAYSTONE: Claystone in this instance refers to the claystone members within the broad ‘mudstone rock’ group, as the finest grained of the detrital sedimentary rocks in this group, with grainsize below 0.004 mm, claystone provides extensive surface area and retention capabilities to the final crushed, ground and blended product of the invention. The platey, sheet-like layered structure of claystone requires low energy input to process while the common occurrence of claystone does not limit access to source materials.

The suitable claystone for use in the invention is easily identified in hand specimen by the soft powdery texture when dry and malleable nature of the rock when wet. Colour may vary greatly but provides a useful primary tool in determining the suitability of a deposit for use in the invention. In the instance where compositional banding is present, providing a range of colours, the two dominant colours are preferably used in preliminary source rock evaluation. Where colour ranges from near colourless to yellow brown this indicates a strong illite content and is highly suitable for use in the invention. Where colour ranges from colourless to pale yellow this indicates the kaolin group of minerals (dickite, halloysite, nacrite and kaolinite) these clays are also preferable for use in the invention.

Where colour ranges are deep red-brown to browns and have a greasy texture between the fingers this indicates the clay to be of the smectite or montmorillonite group, these clays exhibit shrink swell capabilities and are less suitable for use in the invention where the final product is to be used in construction operations. Additions of smectite dominated claystone are preferably kept below 50% of the preferred claystone content of the final products of the invention.

Further recommendations for Claystone selection include:
where concretions constitute more than 30% of the claystone and are greater than 0.05 millimetres in average size, the deposit is not recommended for use in the invention;,
where abundant iron concretions coalesce these clays are also not recommended for use in the invention;
where the source rock deposit has undergone regional, contact or localised metamorphism to no greater than the phyllite grade of alteration and mineralogical composition has not altered completely to or near pelitic composition the source rock remains suitable for use in the invention where the original sedimentary fabric remains visible to the naked eye in hand specimen.

LIMESTONE: In this instance ‘limestone’ refers to any rocks where the proportion of carbonate material exceeds the remaining constituents with the exception of dolomite (90-100% dolomite), dolomitic limestone (10 to 50% dolomite) and calcareous dolomite (50-90% dolomite). The dolomite group of limestone rocks are described separately below to assist in maintaining clear guidelines for source rock analysis 13.

In hand specimen the preferred limestone should not display heavy iron oxide stains/staining along cleavage and grain boundaries, as this is indicative of excessive siderite content. The primary determining factor for the selection of source rock limestone is the determination of the optimum potential Effective Neutralising Value (ENV) a deposit may attain, that is 100%× the Neutralising Value (NV) of the limestone. Where the NV, determined by laboratory analysis, of the proposed limestone source rock is greater than 95%, the limestone is highly suitable for use in the invention as the grinding stage 16 ensures the optimum potential ENV is attained. Where the NV, determined by laboratory analysis, is below 95% but greater than 92%, the proposed limestone source rock is suitable for use in the invention where the limestone component, of the entire individual product blend, is added at high rates (high rates in this instance refer to the upper 50 percentile fraction of the total recommended range) with respect to ranges specified in each mode of the invention.

Further recommendations for limestone source rock selection include:
Limestone/s for use in the invention may preferably have siderite content below 10% of their modal abundance to assist in reducing overall final product iron content as a precautionary measure where iron levels are of concern.
Where a limestone has an average abundance, determined by laboratory analysis, equal to or greater than:
   1 mg per kilogram of cadmium, and/or;
   20 mg per kilogram of lead, and/or;
   0.2 mg per kilogram of mercury the limestone is highly unsuitable for use in the invention. This restriction negates the risk of exceeding Maximum Permissible Concentration (MPC) levels of residues capable of accumulation in soil, plant and animal products.

DOLOMITE: In this instance dolomite refers to the digenetic carbonate mineral assemblage found in magnesium rich limestone and commonly known as dolomite, dolostone, calcic dolomite, dololithe and dolomitic limestone. Selection of optimum dolomite source rocks is often difficult as the dolomization process often destroys sedimentary fabric. Further, the vast range of colours occurs over the majority of suitable source rock deposits. Determination of a potential source rock deposits suitability for use in the invention requires laboratory analyses to obtain calcium and magnesium as carbonate levels as a percentage of whole rock modal abundance. Where a potential source rock deposit has below 15% magnesium as carbonate and at least 12% calcium content the deposit is highly suitable for use in the invention.

The next step is crushing 11 the source rocks to a particular size fraction. In this embodiment, the size fraction required at this stage is at or below 20 mm. The crushing 11 may preferably be performed under dry conditions but is suitable under wet conditions. This stage may require stock to feed and re-feed through a single crushing unit or may preferably feed through a larger stock feed crushing unit through into a small stock feed crushing unit to reduce energy required to complete stage 11.

After the crushing stage 11, all production lines are subject to size determination 12 to ensure the correct size fraction is obtained during the crushing stage 11. The basalt and dolomite lines are also subject to neutralising value and/or attribute analysis 10.

The next step for all production lines is stockpiling and/or drying 15. This stage removes some of the waters that may have been added in the crushing stage 11.

The next step is the grinding stage 16. Grinding is a process utilizing machinery differed to that used in crushing stage 11. Crushing generally gives a courser product than grinding. All lines are finely ground to give a grinding size fraction in the range of 0.040 millimetres up to 1.5 millimetres.

Where the basalt size fraction ranges from 0.040 millimetres to 0.080 millimetres optimum performance for this embodiment of the invention is realised, basalt size fractions up to a maximum grainsize no greater than 1.2 millimetres are suitable for use in the invention where no greater than 30% of the entire basalt component is above the upper optimum performance grainsize of 0.080 millimetres.

Where the limestone size fraction ranges from 0.040 millimetres to 0.090 millimetres optimum performance of limestone for this embodiment of the invention is realised, limestone size fractions up to a maximum grainsize no greater than 0.3 millimetres are suitable for use in the invention where no greater than 50% of the entire limestone component is above the upper optimum performance grainsize of 0.090 millimetres.

Where the dolomite size fraction ranges from 0.060 millimetres to 0.5 millimetres optimum performance for dolomite in this embodiment of the invention are realised, dolomite size fractions up to a maximum grainsize no greater than 1.5 millimetres are suitable for use in the invention where no greater than 30% of the entire dolomite component is above the upper optimum performance grainsize of 0.5 millimetres.

Where the claystone size fraction ranges from 0.080 millimetres to 0.5 millimetres optimum performance for claystone in this embodiment of the invention is realised, claystone size fractions up to a maximum grainsize no greater than 1.5 millimetres are suitable for use in the invention where no greater than 30% of the entire claystone component is above the upper optimum performance grainsize of 0.080 millimetres.

After the grinding stage 16, the limestone production line is tested for neutralising value and/or attribute analysis 10 to ensure all grains are below 0.3 mm and preferably within the required size range of 0.040 millimetres to 0.090 millimetres so optimum neutralising value of the limestone line is attained.

The basalt and dolomite lines are stockpiled or refined 15 to ensure the required quantity of each rock or mineral is present at the desired grainsize range after grinding 16, before they are blended 17 with the limestone line which exits the neutralising value and/or attribute analysis 10.

The blend of the three minerals/rocks exiting the refining stage 17, is stockpiled. The blend is then further blended 17 with the claystone exiting grinding stage 16 to form the final product under this embodiment.

The final stage in this process is a quality check of neutralising value and/or attribute analysis to ensure product quality and that the required rocks/minerals are present in the desired modal abundances. The product then proceeds to packing and distribution.

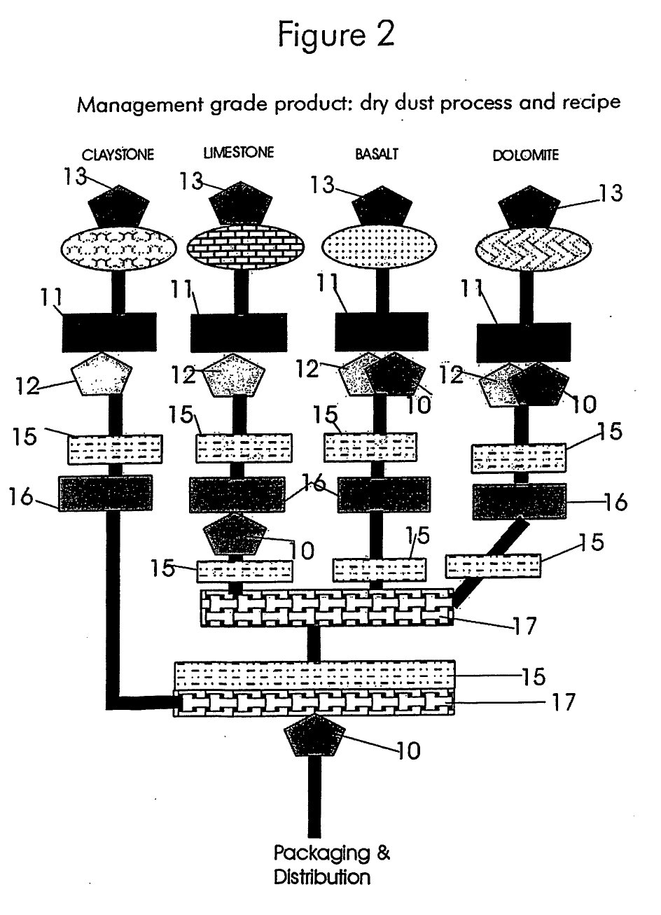

According to a second embodiment, the final product is produced according to the production flowsheet given in FIG. 2 and is the management grade product described above. The overall process may be explained by analysing the series of subsidiary processes involved.

The source rocks undergo analysis 13 to determine the mineralogical, physical and textural suitability for use in the invention. This analysis 13 involves, identifying a series of mineralogical and textural characteristics highly desired in source rocks to be used in the invention. The preferred individual source rocks and their desired attributes to complete analysis 13 are individually defined above in the analysis 13 for the planning grade product and remain the same for the management and shock grade product lines.

The next step is crushing 11 the source rocks to a particular size fraction. In this embodiment, the size fraction required at this stage is at or below 20 mm. The crushing 11 may preferably be performed under dry conditions but is suitable under wet conditions. This stage may require stock to feed and re-feed through a single crushing unit or may preferably feed through a larger stock feed crushing unit through into a small stock feed crushing unit to reduce energy required to complete stage 11.

After the crushing stage 11, all production lines are subject to size determination 12 to ensure the correct size fraction is obtained during the crushing stage 11. The basalt and dolomite lines are also subject to neutralising value and/or attribute analysis 10.

The next step for all production lines is stockpiling and/or drying 15. This stage removes some of the waters that may have been added in the crushing stage 11.

The next step is the grinding stage 16. Grinding is a process utilizing machinery differed to that used in crushing stage 11. Crushing generally gives a courser product than grinding. All lines are finely ground to give a grinding size fraction in the range of 0.040 millimetres up to 1.5 millimetres.

Where the basalt size fraction ranges from 0.040 millimetres to 0.075 millimetres optimum performance for this embodiment of the invention is realised, basalt size fractions up to a maximum grainsize no greater than 1.1 millimetres are suitable for use in the invention where no greater than 20% of the entire basalt component is above the upper optimum performance grainsize of 0.075 millimetres.

Where the limestone size fraction ranges from 0.040 millimetres to 0.085 millimetres optimum performance of limestone for this embodiment of the invention is realised, limestone size fractions up to a maximum grainsize no greater than 0.3 millimetres are suitable for use in the invention where no greater than 35% of the entire limestone component is above the upper optimum performance grainsize of 0.085 millimetres.

Where the dolomite size fraction ranges from 0.055 millimetres to 0.250 millimetres optimum performance for dolomite in this embodiment of the invention are realised, dolomite size fractions up to a maximum grainsize no greater than 1.5 millimetres are suitable for use in the invention where no greater than 20% of the entire dolomite component is above the upper optimum performance grainsize of 0.250 millimetres.

Where the claystone size fraction ranges from 0.060 millimetres to 0.5 millimetres optimum performance for claystone in this embodiment of the invention is realised, claystone size fractions up to a maximum grainsize no greater than 1.5 millimetres are suitable for use in the invention where no greater than 30% of the entire claystone component is above the upper optimum performance grainsize of 0.060 millimetres.

After the grinding stage 16, the limestone production line is tested for neutralising value and/or attribute analysis 10 to ensure all grains are below 0.3 mm and preferably within the required size range of 0.040 millimetres to 0.085 millimetres so optimum neutralising value of the limestone line is attained.

The basalt and dolomite lines are stockpiled or refined 15 to ensure the required quantity of each rock or mineral is present at the desired grainsize range after grinding 16, before they are blended 17 with the limestone line which exits the neutralising value and/or attribute analysis 10.

The blend of the three minerals/rocks exiting the refining stage 17, is stockpiled. The blend is then further blended 17 with the claystone exiting grinding stage 16 to form the final product under this embodiment.

The final stage in this process is a quality check of neutralising value and/or attribute analysis to ensure product quality and that the required rocks/minerals are present in the desired modal abundances. The product then proceeds to packing and distribution.

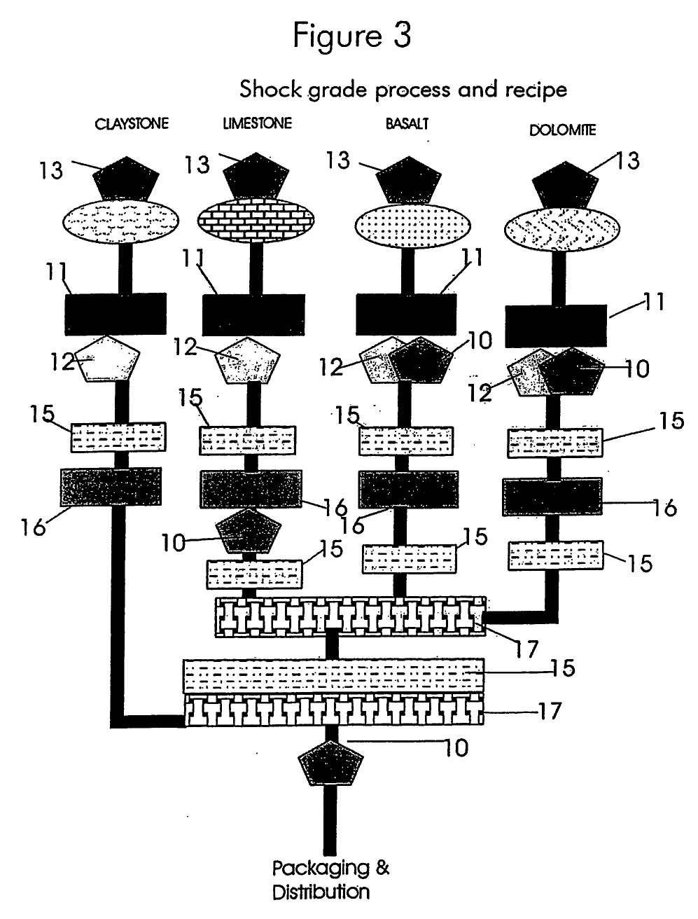

According to a third embodiment, the final product is produced according to the production flowsheet given in FIG. 3 and is the Shock grade product described above. The overall process may be explained by analysing the series of subsidiary processes involved.

The source rocks undergo analysis to determine the mineralogical, physical and textural suitability for use in the invention. This analysis 13 involves, identifying a series of mineralogical and textural characteristics highly desired in source rocks to be used in the invention. The preferred individual source rocks and their desired attributes to complete analysis 13 are individually defined above in the analysis 13 for the planning grade product and remain the same for the management and shock grade product lines.

The next step is crushing 11 the source rocks to a particular size fraction. In this embodiment, the size fraction required at this stage is at or below 20 mm. The crushing 11 may preferably be performed under dry conditions but is suitable under wet conditions. This stage may require stock to feed and re-feed through a single crushing unit or may preferably feed through a larger stock feed crushing unit through into a small stock feed crushing unit to reduce energy required to complete stage 11.

After the crushing stage 11, all production lines are subject to size determination 12 to ensure the correct size fraction is obtained during the crushing stage 11. The basalt and dolomite lines are also subject to neutralising value and/or attribute analysis 10.

The next step is the grinding stage 16. Grinding is a process utilizing machinery differed to that used in crushing stage 11. Crushing generally gives a courser product than grinding. All lines are finely ground to give a grinding size fraction in the range of 0.030 millimetres up to 1.5 millimetres.

Where the basalt size fraction ranges from 0.030 millimetres to 0.070 millimetres optimum performance for this embodiment of the invention is realised, basalt size fractions up to a maximum grainsize no greater than 1 millimetre are suitable for use in the invention where no greater than 10% of the entire basalt component is above the upper optimum performance grainsize of 0.070 millimetres.

Where the limestone size fraction ranges from 0.030 millimetres to 0.075 millimetres optimum performance of limestone for this embodiment of the invention is realised, limestone size fractions up to a maximum grainsize no greater than 0.3 millimetres are suitable for use in the invention where no greater than 20% of the entire limestone component is above the upper optimum performance grainsize of 0.075 millimetres.

Where the dolomite size fraction ranges from 0.030 millimetres to 0.075 millimetres optimum performance for dolomite in this embodiment of the invention are realised, dolomite size fractions up to a maximum grainsize no greater than 1 millimetre are suitable for use in the invention where no greater than 10% of the entire dolomite component is above the upper optimum performance grainsize of 0.075 millimetres.

Where the claystone size fraction ranges from 0.040 millimetres to 0.5 millimetres optimum performance for claystone in this embodiment of the invention is realised, claystone size fractions up to a maximum grainsize no greater than 1 millimetre are suitable for use in the invention where no greater than 20% of the entire claystone component is above the upper optimum performance grainsize of 0.060 millimetres.

After the grinding stage 16, the limestone production line is tested for neutralising value and/or attribute analysis 10 to ensure all grains are below 0.3 mm and preferably within the required size range of 0.030 millimetres to 0.075 millimetres so optimum neutralising value of the limestone line is attained.

The basalt and dolomite lines are stockpiled or refined 15 to ensure the required quantity of each rock or mineral is present at the desired grainsize range after grinding 16, before they are blended 17 with the limestone line which exits the neutralising value and/or attribute analysis 10.

The blend of the three minerals/rocks exiting the refining stage 17, is stockpiled. The blend is then further blended 17 with the claystone exiting grinding stage 16 to form the final product under this embodiment.

The final stage in this process is a quality check of neutralising value and/or attribute analysis to ensure product quality and that the required rocks/minerals are present in the desired modal abundances. The product then proceeds to packing and distribution.

In the present specification and claims, the word “comprising” and its derivatives including “comprises” and “comprise” include each of the stated integers but does not exclude the inclusion of one or more further integers.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A soil additive produced from crushing, grinding and blending specified source rocks wherein a final product contains at least three of andesite, basalt, limestone, dolomite and claystone.

2. A soil additive as claimed in claim 1 wherein the final product has a modal abundance of basalt in the range of 11% to 91%, limestone in the range of 1% to 59%, dolomite in the range of 0.25% to 30% and claystone in the range of 0% to 17.5%.

3. A soil additive as claimed in claim 2 wherein the final product has a modal abundance of basalt in the range of 50% to 90.5%, limestone in the range of 1% to 22.5%, dolomite in the range of 0.25% to 12.5% and claystone in the range of 0% to 17.5%.

4. A soil additive as claimed in claim 2 wherein the final product has a modal abundance of basalt in the range of 50% to 81.5%, limestone in the range of 3% to 28.5%, dolomite in the range of 0.5% to 18.5% and claystone in the range of 0% to 12%.

5. A soil additive as claimed in claim 2 wherein the final product has a modal abundance of basalt in the range of 11% to 79.5%, limestone in the range of 10% to 59%, dolomite in the range of 1% to 30% and claystone in the range of 0% to 8%.

6. A soil additive as claimed in claim 1 wherein the final product has a modal abundance of andesite in the range of 0-20%, limestone in the range of 0-45%, dolomite in the range of 0-20%, and basalt in the range of 50-85%.

7. A soil additive as claimed in claim 6 wherein the final product has a modal abundance of andesite in the range of 0-20%, limestone in the range of 0-30%, dolomite in the range of 0-10%, and basalt in the range of 60-85%.

8. A soil additive as claimed in claim 6 wherein the final product has a modal abundance of andesite in the range of 0-15%, limestone in the range of 0-45%, dolomite in the range of 0-15%, and basalt in the range of 55-80%.

9. A soil additive as claimed in claim 6 wherein the final product has a modal abundance of andesite in the range of 0-15%, limestone in the range of 0-45%, dolomite in the range of 0-20%, and basalt in the range of 50-75%.

10. A soil additive produced from blending source rocks in the form of blending crushing waters produced by crushing a first source rock containing at least one of andesite, limestone, dolomite, basalt and claystone with crushing waters produced by crushing at least two second source rocks chosen from the group of andesite, limestone, dolomite, basalt and claystone.

11. A method for producing a soil additive comprising the steps of
a. conducting analysis of mineralogy and/or crystalline structure of bulk rocks to determine the applicability of the bulk rocks to be used as a limestone source rock, a basalt source rock, a dolomite source rock or a claystone source rock,
b. crushing each of the source rocks identified in the analysis,
c. size analysis of each of the source rocks to determine whether each source rock is of a predetermined size,
d. grinding of each of the source rocks, and
e. blending of the source rocks to give a final blend.

12. The method for producing a soil additive as claimed in claim 11 wherein each of the source rocks are processed in a separate processing stream, being a limestone processing stream, a basalt processing stream, a dolomite processing stream or a claystone processing stream, to produce a product, the products from each separate processing stream combined to form the final blend.

13. The method for producing a soil additive as claimed in claim 11 wherein the crushing step reduces the source rocks to a particular size fraction.

14. The method for producing a soil additive as claimed in claim 11 wherein the size fraction is at or below 20 mm.

15. The method for producing a soil additive as claimed in claim 12 wherein after the crushing stage, each processing stream is subjected to size determination to ensure the correct size fraction is obtained during the crushing stage.

16. The method for producing a soil additive as claimed in claim 15 wherein the basalt and dolomite processing steams are subjected to neutralising value and/or attribute analysis.

17. The method for producing a soil additive as claimed in claim 15 wherein each processing stream is subjected to at least one drying steps to remove at least some moisture from the respective processing streams.

18. The method for producing a soil additive as claimed in claim 11 wherein during the grinding step, each processing stream is finely ground to give a grinding size fraction in the size range of 0.030 millimetres up to 1.5 millimetres.

19. The method for producing a soil additive as claimed in claim 18 wherein size fraction ranges of the basalt processing stream is from 0.030 millimetres to 0.080 millimetres after the grinding step.

20. The method for producing a soil additive as claimed in claim 18 wherein size fraction ranges of the limestone processing stream is from 0.030 millimetres to 0.090 millimetres after the grinding step.

21. The method for producing a soil additive as claimed in claim 18 wherein size fraction ranges of the dolomite processing stream is from 0.030 millimetres to 0.5 millimetres after the grinding step.

22. The method for producing a soil additive as claimed in claim 18 wherein size fraction ranges of the claystone processing stream is from 0.040 millimetres to 0.5 millimetres after the grinding step.

23. The method for producing a soil additive as claimed in claim 11 wherein after the grinding stage, the limestone processing stream is tested for neutralising value and/or attribute analysis to ensure a grain size within the range of 0.030 millimetres to 0.090 millimetres.
